(19) United States
(12) Patent Application Publication
(10) Pub. No.: US 2015/0015994 A1
(43) Pub. Date: Jan. 15, 2015

(54) ROTARY DEVICE

(71) Applicant: Samsung Electro-Mechanics Japan Advanced Technology Co., Ltd., Shizuoka (JP)

(72) Inventor: Ryusuke SUGIKI, Shizuoka (JP)

(73) Assignee: Samsung Electro-Mechanics Japan Advanced Technology Co., Ltd.

(21) Appl. No.: 14/326,536

(22) Filed: Jul. 9, 2014

(30) Foreign Application Priority Data
Jul. 11, 2013 (JP) 2013-145414

(51) Int. Cl. G11B 19/20

(52) U.S. Cl. CPC G11B 19/2045
USPC 360/99.12

(57) ABSTRACT

A rotary device includes a fixed member including a shaft body having first and second shaft ends, a rotating member being rotatably supported by the fixed member and including a bearing body that accommodates the second shaft end, and a fitting part to which a recording disk is to be fitted at a fitting section, and dynamic pressure generation parts provided in a space between the fixed member and the rotating member. The fitting section includes a first end provided toward the first shaft end and a second end provided toward the second shaft end. The bearing body is supported by the shaft body at a radial gap section extending between the dynamic pressure generation parts in an axial direction of the shaft body. The second end of the fitting section is positioned within the radial gap section with respect to the axial direction.

### BACKGROUND OF THE INVENTION

1. Field of the Invention

The present invention generally relates to a rotary device.

2. Description of the Related Art

As one type of rotary device, there is a disk drive device such as a hard disk drive. Such disk drive device is known to have a configuration including a fixed shaft and a hub surrounding the shaft, in which the hub is rotated together with multiple disks attached to its peripheral part (see, for example, Japanese Laid-Open Patent Publication No. 2010-286071).

In the disk drive device of Japanese Laid-Open Patent Publication No. 2010-286071, a section at which the hub engages the multiple disks and a section at which the hub is supported by the shaft are different with respect to an axial direction of the shaft. That is, the hub is provided to engage with the multiple disks and rotate together with the multiple disks at a section higher than a section at which the hub is supported by the shaft with respect to the axial direction of the shaft.

With the above-described configuration, the dynamic pressure exerted on a lubricant provided in-between the shaft and the hub may become inconsistent and may cause the rotation of the hub to become unstable. Further, a large load is applied to the motor. Thus, the life-span of the disk drive device may become shorter.

### SUMMARY OF THE INVENTION

The present invention may provide a rotary device that substantially obviates one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by a rotary device particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides a rotary device including: a fixed member including a shaft body having a first shaft end and a second shaft end opposite to the first shaft end; a rotating member that is rotatably supported by the fixed member, the rotating member including a bearing body that accommodates the second shaft end, and a fitting part to which a recording disk is to be fitted at a disk fitting section; and first and second dynamic pressure generation parts provided in a space between the fixed member and the rotating member; wherein the disk fitting section includes a first end provided toward the first shaft end and a second end provided toward the second shaft end, wherein the bearing body is supported by the shaft body at a radial gap section extending between the first and second dynamic pressure generation parts in an axial direction of the shaft body, wherein the second end of the disk fitting section is positioned within the radial gap section with respect to the axial direction.

Other objects and further features of the present invention will be apparent from the following detailed description when read in conjunction with the accompanying drawings.

### BRIEF DESCRIPTION OF THE DRAWINGS

FIGS. 1A-1C are schematic diagrams illustrating a disk drive device according to the first embodiment of the present invention;

FIG. 2 is a cross-sectional view of a disk drive device according to the first embodiment of the present invention;

FIG. 3 is a schematic diagram for describing a disk fitting section and a radial gap according to an embodiment of the present invention;

FIG. 4 is a cross-sectional view illustrating a configuration of a disk drive device according to the second embodiment of the present invention;

FIG. 5 is a cross-sectional view illustrating a configuration of a disk drive device according to the third embodiment of the present invention; and

FIG. 6 is a cross-sectional view illustrating a configuration of a disk drive device according to the fourth embodiment of the present invention.

### DESCRIPTION OF EMBODIMENTS

In the following, embodiments of the present invention will be described with reference to the accompanying drawings. Throughout the drawings, like components/parts are denoted with like reference numerals and detail explanation may be omitted where appropriate. In the detailed description of the embodiments of the present invention, the sizes of constituent elements may be enlarged or reduced in the drawings for aiding understanding of the embodiments of the present invention. Some of the components/parts in the drawings may be omitted for the sake of explanation.

### <Configuration of Disk Drive Device>

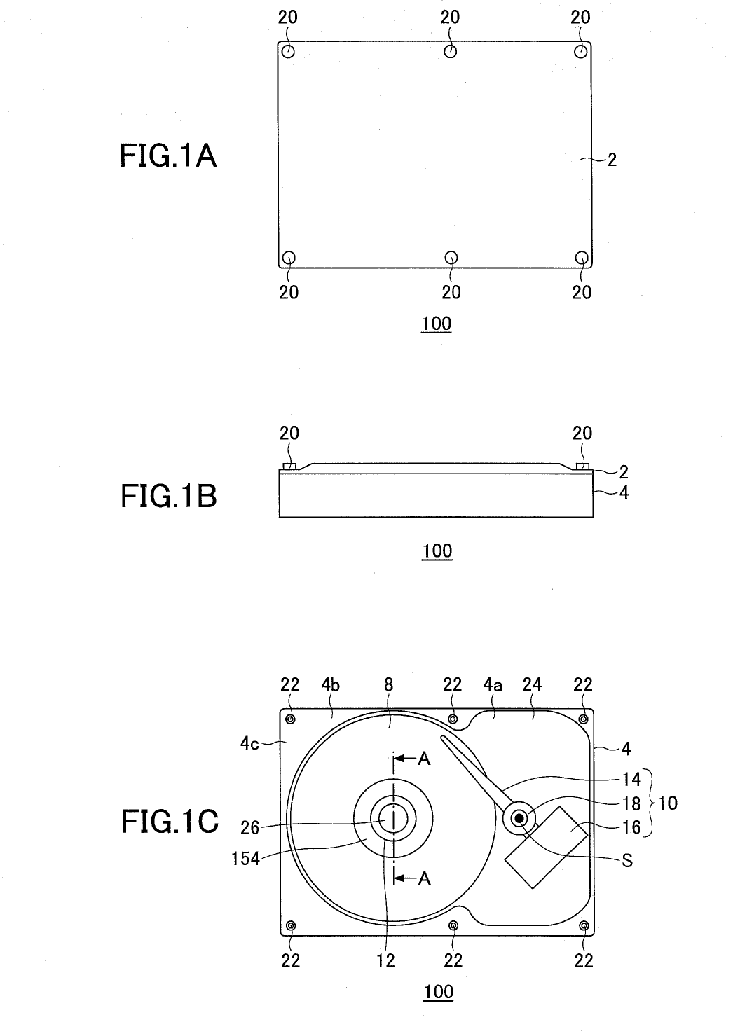

FIGS. 1A-1C illustrate a disk drive device 100, which is an example of a rotary device, according to an embodiment of the present invention. FIG. 1A is an upper plan view of the disk drive device 100. FIG. 1B is a side view of the disk drive device 100. FIG. 1C is an upper plan view of the disk drive device 100 in a case where a top cover 2 is removed from the disk drive device 100.

The disk drive device 100 includes the top cover 2 and a base 4. Further, the disk drive device 100 has a magnetic recording disk 8 and a data read/write part 10 provided within the top cover 2 and the base 4.

In the following description, an “upper side” refers to a side toward the top cover 2 and a “lower side” refers to a side toward the base 4 in a state where the top cover 2 is attached to the base 4.

### (Base)

As illustrated in FIG. 10, the base 4 includes a bottom plate 4a that forms a bottom part of the disk drive device 100 and an outer peripheral wall 4b that is formed along the outer periphery of the base plate 4a in a manner surrounding an area for mounting the magnetic recording disk 8.

The base 4 according to an embodiment of the present invention is formed by, for example, performing a die cast process using an aluminum alloy. However, the base 4 may be formed by using other methods. For example, the base 4 may be formed by performing a pressing process using a metal plate such as an aluminum plate or an iron plate. In this case, an emboss process may also be performed in which projecting parts are formed on an upper side of the base 4. By performing the emboss process on a predetermined part of the base, the base 4 can be prevented from deforming.

In order to prevent peeling of the surface of the base 4, a surface coating process is performed on the base 4. For example, a resin material such as epoxy resin may be used as the surface coating. Alternatively, a plating process using a metal material (e.g., nickel, chrome) may be performed as the surface coating process. In this embodiment, a nickel plating is formed on the surface of the base 4 by using an electroless plating process. Compared to a surface coating process using a resin material, the coating formed by the electroless nickel plating process increases the hardness of the surface of the base 4 and reduces the friction coefficient of the surface of the base 4. Further, in the case of, for example, manufacturing the disk drive device 100, the surface of the base 4 and the magnetic recording disk 8 can be prevented from being damaged when the magnetic recording disk 8 contacts the surface of the base 4. In this embodiment, the surface coating process is performed, so that a static friction coefficient of the surface of the base 4 ranges from 0.1 to 0.6. Because the static friction coefficient of the surface of the base 4 is low, the base 4 and the magnetic recording disk 8 can be prevented from being damaged during manufacturing or the like.

Further, the base 4 may be formed as a combination of a sheet metal part and a die-cast part. The sheet metal part may be formed by performing a pressing process on a metal plate such as an aluminum plate or an iron plate. For example, the bottom plate 4a may include the sheet metal part and the outer peripheral wall 4b may include the die-cast part. Owing to such configuration, the rigidity of a screw hole 22 can be prevented from degrading. For example, there is a method of forming the die-cast part by performing an aluminum die-cast process in a state where a ready-made sheet metal part is installed in a mold for the aluminum die cast process. By using this method, a process of attaching the sheet metal part and the die-cast part can be omitted. Thereby, the precision of the dimensions of the sheet metal part and the die-cast part can be improved. Further, an additional component for attaching the sheet metal part and the die-cast part may be omitted or have its size reduced by using the above-described method. As a result, the thickness of the base 4 can be reduced.

### (Top Cover)

As illustrated in FIGS. 1A and 1B, the top cover 2 is fixed to an upper surface 4c of the outer peripheral wall 4b of the base 4 by way of six screws 20 fastened to the screw holes 22 of the upper surface 4c of the base 4.

A disk installing space 24 is provided between the top cover 2 and the base 4. The magnetic recording disk 8 is installed in the disk installing space 24. In order to improve operation reliability, particles are prevented from adhering to the surface of the magnetic recording disk 8. Accordingly, the inside of the disk installing space 24 is filled with clean air from which dust or the like is removed. Thus, the top cover 2 and the base 4 are provided to prevent dust or the like from entering the disk installing space from outside, so that the disk installing space 24 is hermetically sealed.

### (Magnetic Recording Disk)

The magnetic recording disk 8 has a center hole that is to be fitted (engaged) to a hub (not illustrated in FIGS. 1A-1C). One or more magnetic recording disks 8 and spacers (not illustrated in FIGS. 1A-1C) are fixed to a section located between a clamper 154 and a placement part of the hub. The magnetic recording disk is rotated about a shaft 26 together with the hub.

The magnetic recording disk 8 is, for example, a 2.5 inch type magnetic recording disk that is formed of glass. The magnetic recording disk 8 has a diameter of 65 mm and a thickness of 0.65 mm. A center hole that is fitted to the hub has a diameter of 20 mm. In this example, four magnetic recording disks 8 are mounted on the disk drive device 100.

### (Data Read/Write Part)

As illustrated in FIG. 10, the data read/write part 10 includes a recording/reproduction head (not illustrated), a swing arm 14, a voice coil motor 16, and a pivot assembly 18.

The recording/reproduction head, which is attached to a tip of the swing arm 14, records data to and reads data from the magnetic recording disk 8.

The pivot assembly 18 swingably supports the swing arm 14 with respect to the base 4, so that the swing arm 14 swings about a head rotation axis S.

The voice coil motor 16 causes the swing arm 14 to swing about the head rotation axis S and causes the recording/reproduction head to move to a predetermined position above an upper surface of the magnetic recording disk 8. The voice coil motor 16 and the pivot assembly 18 may be configured by the use of a known art for controlling the position of the head.

### <Configuration of Bearing Mechanism>

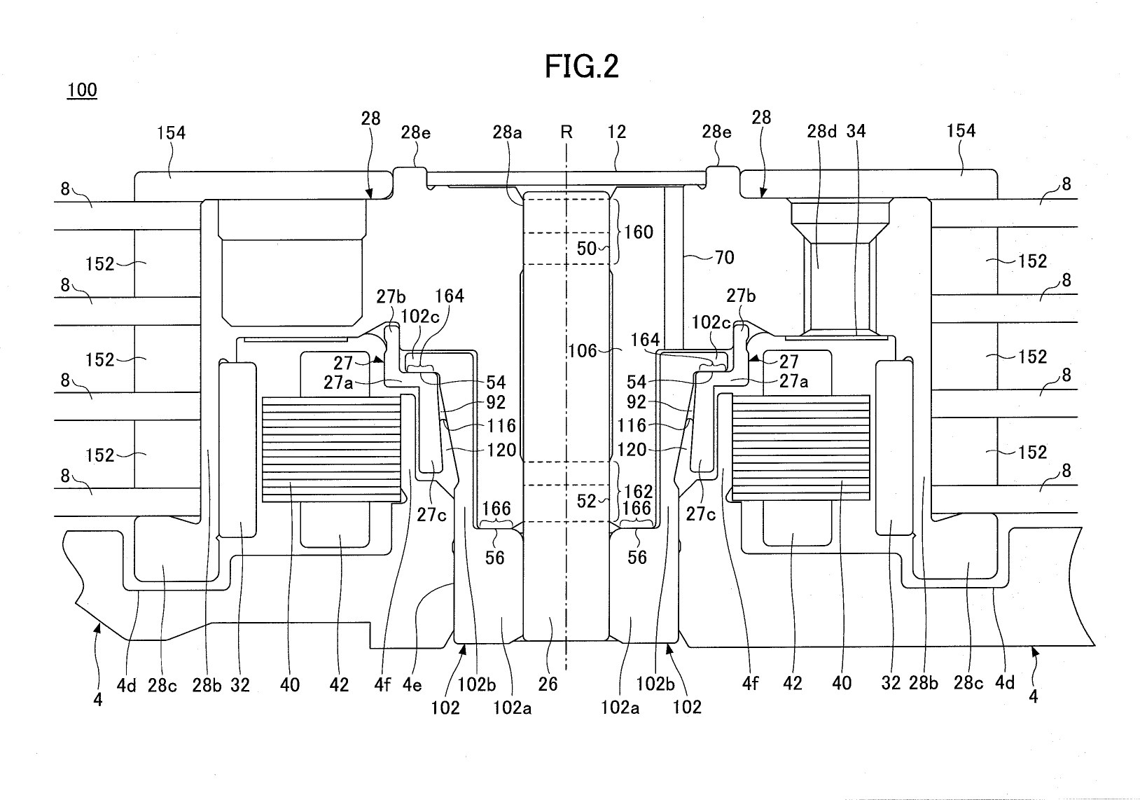

FIG. 2, which is a cross-sectional view of the disk drive device 100 taken along line A-A of FIG. 10, illustrates a configuration of a bearing mechanism of the disk drive device 100 according to a first embodiment of the present invention. In the following description, a direction parallel to a rotation axis R of the shaft 26 may be referred to as “axial direction”, and a direction orthogonal to the rotation axis R may be referred to as “radial direction”. Further, a side farther from the rotation axis R in the radial direction may be referred to as “outer peripheral side”, and a side closer to the rotation axis R in the radial direction may be referred to as “inner peripheral side”.

The disk drive device 100 includes a rotating member that rotates while having the magnetic recording disk 8 placed thereon and a fixed member that rotatably supports the rotating member.

The rotating member includes a hub 28 having a sleeve 106, a cap 12, a thrust member 27, a cylindrical magnet 32, and a clamper 154. The fixed member includes the base 4, the shaft 26, a stator core 40, a coil 42, and a housing 102. The hub 28 that is supported by the shaft 26 and the housing 102 rotates in a state where the shaft 26 is surrounded by the sleeve 106. A lubricant 92 fills in-between the shaft 26 and the sleeve 106.

### (Hub)

The hub 28 is integrally formed with the sleeve 106 that serves as a bearing part. The hub 28 includes an installing hole 28a into which the shaft 26 is installed, a cylindrical part 28b that serves as a fitting part fitted to a center hole of the magnetic recording disk 8, and a placement part 28c provided at a lower edge of the outer peripheral side of the cylindrical part 28b.

The sleeve 106, which is integrally formed with the hub 28, surrounds an upper end side of the shaft 26 that is inserted to the installing hole 28a. The lubricant 92 fills in-between the sleeve 106 and the shaft 26. Alternatively, the sleeve 106 may be formed as an independent component that is separate from, for example, the hub 28. In this case, the sleeve 106 is fixed to the hub 28 by way of press-fitting, adhesive attachment, or both. Alternatively, in the case where the sleeve 106 is an independent component separate from the hub 28, the sleeve 106 may be formed by machining, for example, stainless steel or the like.

The installing hole 28a of the hub 28 is formed at the center of the sleeve 106. The installing hole 28a accommodates an upper end side of the shaft 26. The cylindrical part 28b is formed at an outer peripheral edge of the hub 28. The cylindrical part 28b is a fitting part fitted to the center hole of the magnetic recording disk 8. The placement part 28c, which serves to place the magnetic recording disk 8 thereon, is provided at a lower end of the cylindrical part 28b in a manner projecting toward the outer peripheral side in the radial direction.

In this embodiment, four magnetic recording disks 8 having their center holes fitted to the cylindrical part 28b are placed on the placement part 28c. Further, circular ring-shaped spacers 152 are provided between the magnetic recording disks 8. By holding (sandwiching) the magnetic recording disks 8 between the clampers 154 and the placement part 28c, the magnetic recording disks 8 along with the spacers are fixed to the cylindrical part 28b of the hub 28. Thereby, the magnetic recording disks 8 can rotate together with the hub 28.

An airstream generation part is formed between a lower surface of the placement part 28c of the hub 28 and the base 4. The base 4 includes a groove 4d formed along the placement part 28c of the hub 28. Accordingly, a lower end part of the placement part 28c of the hub 28 rotates by passing through the inside of the groove 4d. An airstream generation groove, which has, for example, a herring bone shape or a spiral shape, is formed at a lower surface of the placement part 28c of the hub 28 or at an upper surface of the groove 4d of the base 4. The airstream generation groove is formed in a manner that the air residing between the placement part 28c of the hub 28 and the groove 4d of the base 4 to generates an airstream oriented toward the inner peripheral side. By forming the airstream generation part, the lubricant 92 can be prevented from emanating to the disk installing space 24.

The hub 28 may be formed by, for example, performing a pressing process or a machining process on a ferrous material (e.g., stainless steel having a soft magnetic property, SUS 430F). By forming the hub 28 with a material having a soft magnetic property, the hub 28 may be configured without being provided with a yoke.

Alternatively, instead of forming the hub 28 with a ferrous material, the hub 28 may be formed by performing, for example, a forging process or a die-cast process on an aluminum alloy material. Further, a machining process may be performed on a predetermined part of the above-described material, so that the hub 28 can be precisely formed with a predetermined dimension. A cylindrical yoke may be attached to the hub 28 in a manner surrounding the cylindrical magnet 32. The yoke is formed by performing a pressing process on a steel plate having a soft magnetic property. Thereby, the yoke functions as a back yoke of the cylindrical magnet 32. By using an aluminum alloy material to form the hub 28, the weight of the hub 28 can be reduced.

Alternatively, instead of forming the hub 28 with a metal material, a resin material such as liquid crystal polymer may be used to form the hub 28. By using a resin material to form the hub 28, the weight of the hub 28 can be reduced.

Further, a surface processing method such as a plating process (e.g., electroless nickel plating process) or a coating process (e.g., resin coating process) may be performed on the hub 28. By performing the surface process method, fine-sized residue can be prevented from peeling from a target process surface of the hub 28.

### (Housing)

The housing 102 includes a circular ring-shaped support part 102a that supports the shaft 26, a cylindrical part 102b that projects upward from an outer peripheral edge of the support part 102, and a flange part 102c that projects toward the outer peripheral side in the radial direction from an upper end of the cylindrical part 102b. The cylindrical part 102b surrounds the lower end part of the sleeve 106. The support part 102a of the housing 102 fixes and supports the shaft 26. The end part of the shaft 26 is attached to the support part 102a by way of press-fitting, adhesive attachment, or both.

Alternatively, the support part 102a, the cylindrical part 102b, and the flange part 102c may be separate components that constitute the housing 102. By constituting the housing 102 with the separate components, it becomes easy to process each of the separate components of the housing 102. In this embodiment, however, the support part 102a, the cylindrical part 102b, and the flange part 102c are integrally formed. By integrally forming the housing 102, manufacturing error can be reduced and a bonding process can be simplified.

For example, a copper type alloy, a sintered alloy formed by powder metallurgy, or stainless steel may be used to form the housing 102. Alternatively, a plastic material such as polyetherimide, polyimide, or polyamide may be used to form the housing 102. In the case of forming the housing 102 with a plastic material, the plastic material is preferred to be a plastic material including carbon fiber, so that the unique (specific) electrical resistance of the housing 102 can be less than or equal to 10⁶Ω·m for ensuring an electrostatic removing function of the disk drive device 100. In this embodiment, however, the housing 102 is formed by performing a machining process on a stainless steel material.

### (Shaft)

The shaft 26 is fixed to the housing 102 by attaching the lower end part of the shaft 26 to the support part 102a of the housing 102 by way of press-fitting, adhesive attachment, or both. The upper end part of the shaft 26 is inserted to the installing hole 28a of the hub 28 and is surrounded by the sleeve 106. The shaft 26 is formed by, for example, performing a machining process on a stainless steel material (e.g., SUS 420J).

### (Thrust Member)

The thrust member 27 is a circular ring-shaped member that is fixed to the hub 28 in a manner so that the flange part 102c of the housing 102 is sandwiched between the lower surface of the hub 28 in the axial direction. The thrust member 27 is formed by, for example, performing a machining process on a metal material such as stainless steel or a resin material.

The thrust member 27 includes an surrounding part 27a that surrounds the cylindrical part 102b of the housing 102, a circular ring part 27b that is fixed to the hub 28 in a manner protruding upward from the outer peripheral edge of the surrounding part 27a, and a hanging part 27c that surrounds the housing 102 in a manner projecting downward from the inner peripheral edge of the surrounding part 27a.

The flange part 102c is provided between the upper surface of the surrounding part 27a and the lower surface of the hub 28 in a manner sandwiching the flange part 102c of the housing 102 therebetween. Further, the circular ring part 27b is fixed to the lower surface of the hub 28 by way of press-fitting, adhesive attachment, or both. Thereby, the thrust member 27 is fixed to the hub 28 and rotates together with the hub 28.

Owing to the above-described configuration, the hub 28 can be prevented from detaching from the shaft 26 even in a case where the disk drive device 100 receives shock in the axial direction. This is because the surrounding part 27a of the thrust member 27 is caught by the flange part 102c of the housing 102.

### (Clamper)

The clamper 154 is, for example, fixed to the upper surface of the hub 28 by a clamp screw inserted into a clamp screw hole 28d. The clamp screw hole 28d is formed to penetrate the circular ring part 28b of the hub 28. A lower end of the clamp screw hole 28d is blocked by a blocking member 34 such as tape. Because the clamp screw hole 28d is formed with a shape that penetrates the hub 28, processing of the clamper 154 is facilitated. Further, because the clamp screw hole 28d is blocked off by the blocking member 34, the lubricant 92 can be prevented from spreading upward via the clamp screw hole 28d.

### (Cylindrical Magnet)

The cylindrical magnet 32 is adhesively fixed to the inner peripheral surface of the cylindrical part 28b of the hub 28. The cylindrical magnet 32 is formed of, for example, a rare earth magnetic material or a ferrite magnetic material. In this embodiment, the cylindrical magnet 32 is formed by a neodymium type magnetic material.

In a cross section orthogonal to the rotation axis R, the cylindrical magnet 32 has driving magnetic poles (e.g., sixteen poles) arranged in a circumferential direction of a circle having the rotation axis R as its center. A front surface layer is formed on the front surface of the cylindrical magnet 32 by, for example, an electrodeposition process or a spraying process. Thereby, rusting of the cylindrical magnet 32 can be prevented. The cylindrical magnet 32 is radially opposed to twelve salient poles of the stator core 40.

### (Stator Core)

The stator core 40 includes a circular ring part and twelve salient poles extending toward the outer peripheral side from the circular ring part. The stator core 40 includes, for example, multiple layers of thin electromagnetic iron plates that are formed as a united body by caulking. An insulating film may be formed on the front surface of the stator core 40 by, for example, an electrodeposition process or a powder coating process. A coil 42 is wound around each salient pole of the stator core 40. A drive magnetic flux is generated along the salient poles of the stator core 40 by allowing a three-phase driving current of a substantially sinusoidal wave to flow through the coil 42.

The base 4 includes a projecting part 4f that surrounds the thrust member 27 and cylindrically projects upward from the lower surface of the base 4. The stator core 40 is fixed to the base 4 by fitting the outer peripheral surface of the projecting part 4f to a center hole of the circular ring part of the stator core 40. The circular ring part of the stator core 40 is fixed to the projecting part 4f by way of press-fitting, adhesive attachment, or both. In order to reduce the vibration of the stator core 40, 90% or more of a section of the circular ring part of the stator core 40 in its axial direction is to be pressed against the projecting part 4f.

It is to be noted that the stator core 40 may be a solid core that is formed by solidifying a magnetic powder (e.g., sintered magnetic material). Further, the disk drive device 100 of this embodiment is an outer rotor type device that has the cylindrical magnet 32 positioned on the outer peripheral side of the stator core 40. Alternatively, the disk drive device 100 may be an inner rotor type device that has the cylindrical magnet 32 positioned on the inner peripheral side of the stator core 40.

### (Cap)

The circular disk-shaped cap 12 that covers the opening of the installing hole 28a is provided on the upper surface of the hub 28. The cap 12 is fixed to a projecting part 28e that projects from the upper surface of the hub 28. The cap 12 may be fixed to the projecting part 28e by way of press-fitting, adhesive attachment, or both. Thereby, the cap 12 rotates together with the hub 28. The cap 12 prevents the lubricant 92 from scattering inside the disk installing space 24 that has the magnetic recording disks 8 installed therein.

The cap 12 is formed by, for example, performing a machining process on a metal material such as stainless steel or a resin material. It is to be noted that the cap 12 may be formed in the shape of a cup having a circumferential wall extending from a circumferential edge of a disk-like part in the axial direction. Further, the cap 12 may be integrally formed with the hub 28.

### (Dynamic Pressure Generation Part)

The lubricant 92 fills in-between the outer peripheral surface of the shaft 26 and the inner peripheral surface of the sleeve 106, and between the sleeve 106 and the support part 102a/cylindrical part 102b of the housing 102. Further, the lubricant 92 fills in-between the hub 28 and the flange part 102c of the housing 102, and between the cylindrical part 102b of the housing 102 and the thrust member 27. Further, the lubricant 92 fills in-between the cap 12, the shaft 26, and the hub 28.

A first radial dynamic pressure generation part 160 and a second radial dynamic pressure generation part 162 are formed between the outer peripheral surface of the shaft 26 and the inner peripheral surface of the sleeve 106. The first radial dynamic pressure generation part 160 is provided on the upper end side of the shaft 26 whereas the second radial dynamic pressure generation part 162 is provided on the lower end side of the shaft 26. The first and second radial dynamic pressure generation parts 160, 162 are formed to be separated from each other in the axial direction.

The sleeve 106 includes a first radial dynamic pressure generation groove 50 provided at a portion facing the first radial dynamic pressure generation part 160. The first radial dynamic pressure generation groove 50 may have, for example, a herring bone shape or a spiral shape. The sleeve 106 also includes a second radial dynamic pressure generation groove 52 provided at a portion facing the second radial dynamic pressure generation part 162. The second radial dynamic pressure generation groove 52 may have, for example, a herring bone shape or a spiral shape. The first radial dynamic pressure generation groove 50, the second radial dynamic pressure generation groove 52, or both may be formed in the outer peripheral surface of the shaft 26.

A first thrust dynamic pressure generation part 164 is formed between the lower surface of the flange part 102c of the housing 102 and the upper surface of the surrounding part 27a of the thrust member 27. A first thrust dynamic pressure generation groove 54 is formed in the lower surface of the flange part 102c of the housing 102. The first thrust dynamic pressure generation groove 54 may have, for example, a herring bone shape or a spiral shape. It is to be noted that the first thrust dynamic pressure generation groove 54 may be formed in the upper surface of the surrounding part 27a of the thrust member 27.

Further, a second thrust dynamic pressure generation part 166 is formed between the lower surface of the sleeve 106 and the upper surface of the support part 102a of the housing. A second thrust dynamic pressure generation groove 56 is formed in the lower surface of the sleeve 106. The second thrust dynamic pressure generation groove 56 may have, for example, a herring bone shape or a spiral shape. The second thrust dynamic pressure generation groove 56 may be formed in the upper surface of the support part 102a of the housing 102.

When the hub 28 is rotated with respect to the shaft 26 and the base 4, dynamic pressure is generated by the lubricant 92 in each of the first radial dynamic pressure generation part 160, the second radial dynamic pressure generation part 162, the first thrust dynamic pressure generation part 164, and the second thrust dynamic pressure generation part 166. Accordingly, the hub 28 can be supported in the axial direction and the radial direction by the dynamic pressure generated with the lubricant 92 in a non-contacting state with respect to the shaft 26 and the housing 102.

It is to be noted that the hub 28 may include a communication hole(s) that bypass the predetermined areas provided with the lubricant 96, so that the difference of pressure exerted on the lubricant 92 can be reduced. As one example of the communication hole, the hub 28 of this embodiment may include a bypass communication hole 70 that bypasses the upper surface side of the hub 28 and the lower surface side of the hub 28. The bypass communication hole 70 can reduce the difference of pressure exerted on the lubricant 92 provided in the predetermined areas of the disk drive device 100. Accordingly, the behavior of the lubricant 92 can be maintained to be steady.

### (Lubricant)

The lubricant 92 may include, for example, a fluorescent substance. For example, in a case where ultraviolet light or the like is radiated onto the lubricant 92, an effect of the fluorescent substance causes the lubricant 92 to emit a light having a different waveform than a waveform of the light radiated thereto (e.g., green light or blue light). By including the fluorescent substance in the lubricant 92, the below-described gas-liquid interface 116 of the lubricant 92 can be easily inspected. Further, inspection of adherence of the lubricant 92 or inspection of leakage of the lubricant 92 can also be facilitated by including the fluorescent substance in the lubricant 92.

### (Seal Part)

A gas-liquid interface 116 of the lubricant 92 is formed between the outer peripheral surface of the cylindrical part 102b of the housing 102 and the inner peripheral surface of the hanging part 27c of the thrust member 27. A seal part 120 is provided to retain the gas-liquid interface 116 of the lubricant 92.

In the seal part 120, the outer peripheral surface of the cylindrical part 102b of the housing 102 is inclined to form a tapered shape in which the space between the inner peripheral surface of the hanging part 27c of the thrust member 27 and the outer peripheral surface of the cylindrical part 102b gradually becomes wider toward the lower side of the seal part 120. Owing to the shape of the seal part 120, more force is exerted onto the lubricant 92 as the space between the inner peripheral surface of the hanging part 27c of the thrust member 27 and the outer peripheral surface of the cylindrical part 102b becomes narrower toward the upper side of the seal part 120. Accordingly, the lubricant 92 can be sealed in-between the cylindrical part 102b of the housing 102 and the hanging part 27c of the thrust member 27.

### (Disk Fitting Section and Radial Gap)

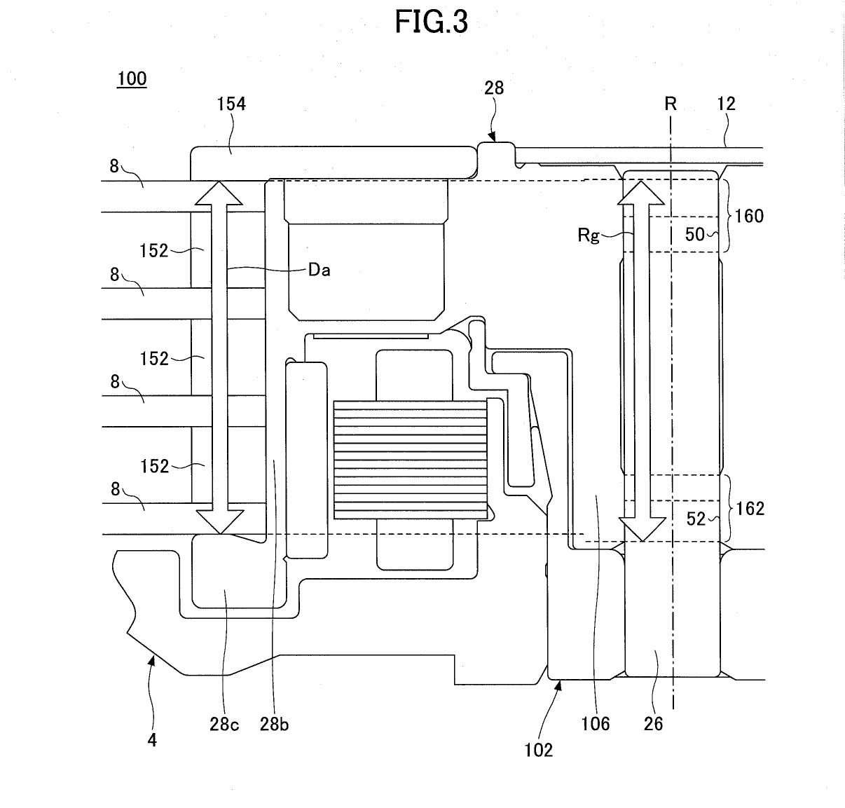

Next, a disk fitting section Da and a radial gap Rg are described with reference to FIG. 3 showing an enlarged view of a part of the disk drive device 100 according to an embodiment of the present invention.

The disk fitting section Da is a section of the disk drive device 100 at which one or more magnetic recording disks 8 are placed on the placement part 28c of the hub 28 interposed by one or more spacers 152. That is, one or more magnetic recording disks 8 have their center holes fitted to the cylindrical part 28b of the hub 28 and are placed on the placement part 28c via one or more spacers 152 at the disk fitting section Da of the disk drive device 100. As illustrated in FIG. 3, the disk fitting section Da is a section that extends from the upper surface of the placement part 28c of the hub 28 to the lower surface of the clamper 154 in the axial direction. That is, the disk fitting section Da is a section that extends from a lowermost surface to an uppermost surface of the one or more magnetic recording disks 8 placed in a superposed manner on the placement part 28c.

As illustrated in FIG. 3, the radial gap Rg is a section that extends from an upper end of the first radial dynamic pressure generation part 160 to a lower end of the second radial dynamic pressure generation part 162 in the axial direction. That is, the radial gap Rg is a section at which the hub 28 is supported by the shaft 26.

In the disk drive device 100 according to the first embodiment of the present invention, the disk fitting section Da is provided in the radial gap Rg in the axial direction. That is, the upper end of the disk fitting section Da is positioned lower than the upper end of the radial gap Rg in the axial direction (i.e. lower than the upper end of the first radial dynamic pressure generation part 160). Further, the lower end of the disk fitting section Da is positioned higher than the lower end of the radial gap Rg in the axial direction (i.e. higher than the lower end of the second radial dynamic pressure generation part 162).

Owing to this configuration, the dynamic pressure exerted onto the lubricant 92 becomes even as the center of gravity of the hub 28 having one or more magnetic recording disks 8 mounted becomes closer to the center of the radial gap Rg. Thereby, the rotation of the hub 28 is stabilized. Further, owing to the stabilization of the rotation of the hub 28, the driving load of the motor of the disk drive device 100 can be reduced. Thus, the life-span of the disk drive device 100 can be increased.

It is to be noted that, even in a case where the lower end of the disk fitting section Da is lower than the lower end of the radial gap Rg (i.e. lower than the lower end of the second radial dynamic pressure generation part 162) in the axial direction, it is possible to attain the same effects as the case where the lower end of the disk fitting section Da is positioned higher than the lower end of the radial gap Rg in the axial direction (i.e. higher than the lower end of the second radial dynamic pressure generation part 162).

Hence, with the disk drive device 100 according to the first embodiment of the present invention, rotation of the hub 28 can be stabilized, and the driving load of the motor of the disk drive device 100 can be reduced. Accordingly, the disk drive device 100 can stably operate for a long period without encountering failure or the like.

### Second Embodiment

Next, a second embodiment of the present invention is described with reference to the accompanying drawings. It is to be noted that like components/parts are denoted with like reference numerals as those of the first embodiment and are not further explained.

### <Configuration of Bearing Mechanism>

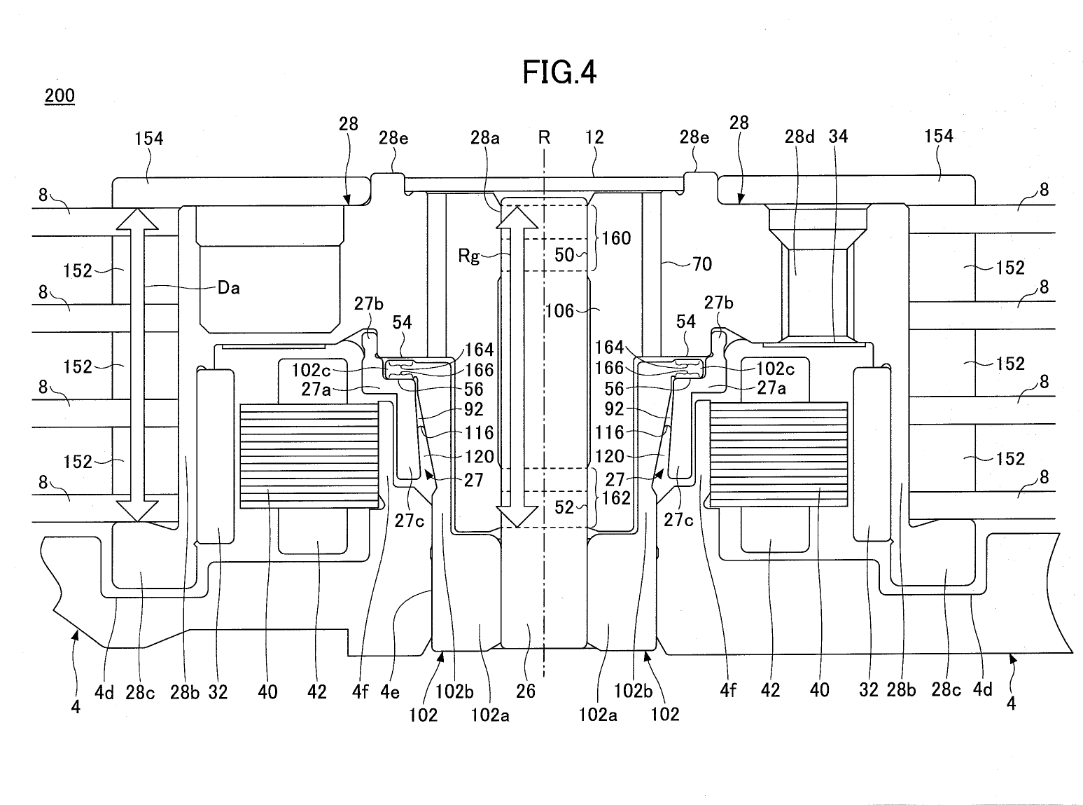

FIG. 4 is a cross-sectional view illustrating a configuration of a bearing mechanism of the disk drive device 200 according to a second embodiment of the present invention.

The disk drive device 200 includes a rotating member that rotates while having one or more magnetic recording disks 8 placed thereon and a fixed member that rotatably supports the rotating member.

The rotating member includes the hub 28 having the sleeve 106 serving as a bearing part, the cap 12, the thrust member 27, the cylindrical magnet 32, and the clamper 154. The fixed member includes the base 4, the shaft 26, the stator core 40, the coil 42, and the housing 102. The hub 28, which is supported by the shaft 26 and the housing 102, rotates in a state where the shaft 26 is surrounded by the sleeve 106. The lubricant 92 is filled between the shaft 26 and the sleeve 106.

### (Dynamic Pressure Generation Part)

The first thrust dynamic pressure generation part 164 is formed between the lower surface of the hub 28 and the upper surface of the flange part 102c. The first thrust dynamic pressure generation groove 54 is formed in the upper surface of the flange part 102c of the housing 102. The first thrust dynamic pressure generation groove 54 may have, for example, a herring bone shape or a spiral shape. It is to be noted that the first thrust dynamic pressure generation groove 54 may be formed in a part of the lower surface of the hub 28 that faces the first thrust dynamic pressure generation part 164.

Further, the second thrust dynamic pressure generation part 166 is formed between the lower surface of the flange part 102c of the housing 102 and the upper surface of the surrounding part 27a of the thrust member 27. The second thrust dynamic pressure generation groove 56 is formed in the lower surface of the flange part 102c of the housing 102. The second thrust dynamic pressure generation groove 56 may have, for example, a herring bone shape or a spiral shape. The second thrust dynamic pressure generation groove 56 may be formed in the upper surface of the surrounding part 27a of the thrust member 27.

When the hub 28 is rotated with respect to the shaft 26 and the base 4, dynamic pressure is exerted on the lubricant 92 in each of the first thrust dynamic pressure generation part 164 and the second dynamic pressure generation part 166. Accordingly, the hub 28 can be supported in the axial direction by the dynamic pressure exerted on the lubricant 92 in a non-contacting state with respect to the housing 102.

### (Disk Fitting Section and Radial Gap)

The disk fitting section Da is a section extending from the upper surface of the placement part 28c of the hub 28 and the lower surface of the clamper 154 in the axial direction. That is, the disk fitting section Da is a section that extends from a lowermost surface to an uppermost surface of the magnetic recording disks 8 placed in a superposed manner on the placement part 28c.

The radial gap Rg is a section that extends from the upper end of the first radial dynamic pressure generation part 160 to the lower end of the second radial dynamic pressure generation part 162 in the axial direction. That is, the radial gap Rg is a section at which the hub 28 is supported by the shaft 26 installed in the installing hole 28a.

In the disk drive device 200 according to the second embodiment of the present invention, the disk fitting section Da is provided in the radial gap Rg in the axial direction. That is, the upper end of the disk fitting section Da is positioned lower than the upper end of the radial gap Rg in the axial direction (i.e. lower than the upper end of the first radial dynamic pressure generation part 160). Further, the lower end of the disk fitting section Da is positioned higher than the lower end of the radial gap Rg in the axial direction (i.e. higher than the lower end of the second radial dynamic pressure generation part 162).

Owing to this configuration, the rotation of the hub 28 is stabilized. Thereby, the driving load of the motor of the disk drive device 200 can be reduced. Thus, the life-span of the disk drive device 200 can be increased.

It is to be noted that, even in a case where the lower end of the disk fitting section Da is lower than the lower end of the radial gap Rg (i.e. lower than the lower end of the second radial dynamic pressure generation part 162) in the axial direction, it is possible to attain the same effects as the case where the lower end of the disk fitting section Da is positioned higher than the lower end of the radial gap Rg in the axial direction (i.e. higher than the lower end of the second radial dynamic pressure generation part 162).

Hence, with the disk drive device 200 according to the second embodiment of the present invention, rotation of the hub 28 can be stabilized, and the driving load of the motor of the disk drive device 200 can be reduced. Accordingly, the disk drive device 200 can stably operate for a long period without encountering failure or the like.

### Third Embodiment

Next, a third embodiment of the present invention is described with reference to the accompanying drawings. It is to be noted that like components/parts are denoted with like reference numerals as those of the third embodiment and are not further explained.

### <Configuration of Bearing Mechanism>

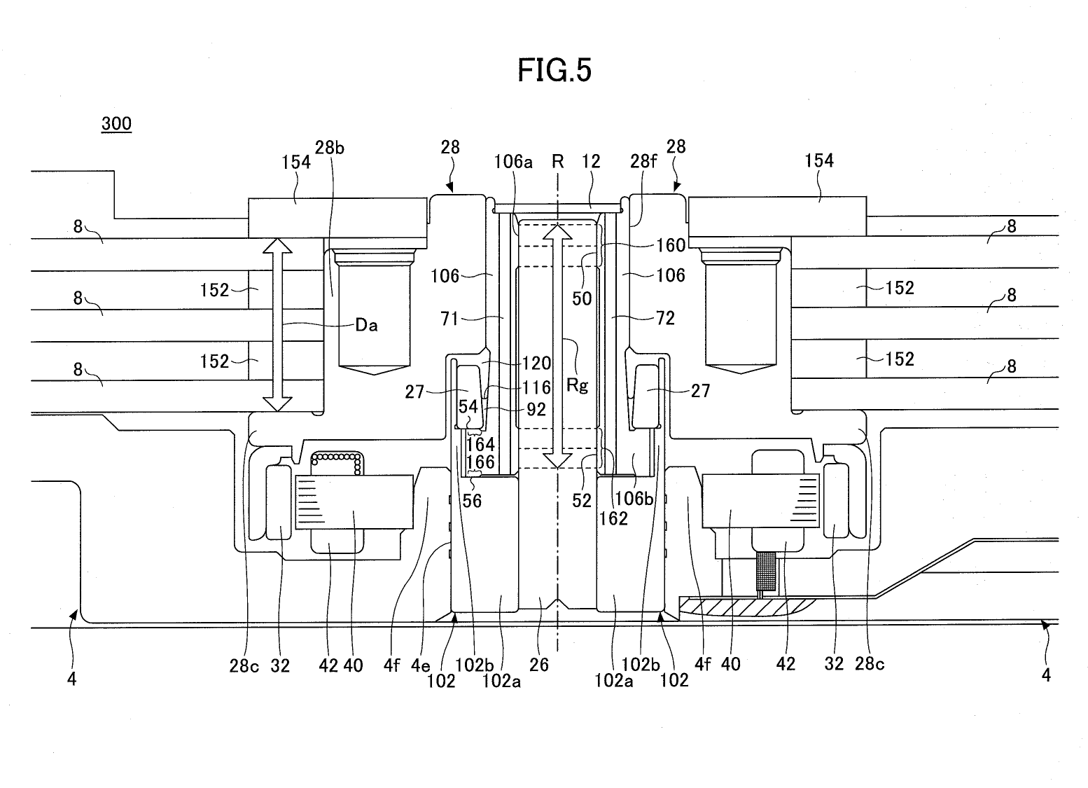

FIG. 5 is a cross-sectional view illustrating a configuration of a bearing mechanism of the disk drive device 300 according to a third embodiment of the present invention.

The disk drive device 300 includes a rotating member that rotates while having one or more magnetic recording disks 8 placed thereon and a fixed member that rotatably supports the rotating member.

The rotating member includes the hub 28, the cap 12, the cylindrical magnet 32, the sleeve 106 serving as a bearing part, and the clamper 154. The fixed member includes the base 4, the shaft 26, the stator core 40, the coil 42, and the housing 102. The hub 28 is rotatably supported by the shaft 26 and the housing 102, and the shaft 26 is surrounded by the sleeve 106. Accordingly, the hub 28 and the sleeve 106 are rotated together. The lubricant 92 fills in-between the shaft 26 and the sleeve 106.

### (Sleeve)

The sleeve 106 surrounds the shaft 26 and is fixed to a sleeve hole(s) 28f provided at the center of the hub 28. The sleeve 106 is rotated together with the hub 28. The sleeve 106 includes an installing hole 106a for installing the shaft 26 therein and a circular ring part 106b that projects from a lower end part of the sleeve 106 to the outer peripheral side in the radial direction.

The circular ring part 106b is sandwiched between the support part 102a of the housing 102 and the thrust member 27 in the axial direction. Owing to this configuration, the hub 28 and the sleeve 106 can be prevented from detaching from the shaft 26 even in a case where the disk drive device 300 receives shock in the axial direction. This is because the circular ring part 106b is caught by the thrust member 27.

The sleeve 106 may be formed into a predetermined shape by, for example, performing a machining process on brass or aluminum and forming a nickel plating thereon. Alternatively, the sleeve 106 may be integrally formed with the hub 28.

### (Cap)

A circular disk-shaped cap 12 that covers the opening of the installing hole 106a is provided on the upper surface of the sleeve 106. The cap 12 is fixed to the upper surface of the sleeve 106. The cap 12 may be fixed to the sleeve 106 by way of press-fitting, adhesive attachment, or both. Thereby, the cap 12 is rotated together with the sleeve 106. The cap 12 prevents the lubricant 92 from scattering inside the disk installing space 24 that has the magnetic recording disks 8 installed therein.

The cap 12 is formed by, for example, performing a machining process on a metal material such as stainless steel or a resin material. It is to be noted that the cap 12 may be formed in the shape of a cup having a circumferential wall extending from a circumferential edge of a disk-like part in the axial direction. Further, the cap 12 may be integrally formed with the hub 28.

### (Hub)

The hub 28 includes the cylindrical part 28b to be fitted to a center hole of the magnetic recording disk 8, the placement part 28c provided at a lower edge of the outer peripheral side of the outer peripheral side of the hub 28, and the sleeve hole(s) 28f to which the sleeve 106 is fixed. The outer peripheral part of the hub 28 is fitted to the center hole of the magnetic recording disk 8. Accordingly, the hub 28 is rotated together with the sleeve 106 and the magnetic recording disk 8.

In this embodiment, three magnetic recording disks 8 having their center holes fitted to the cylindrical part 28b of the hub 28 are placed on the placement part 28c. Further, circular ring-shaped spacers 152 are provided between the magnetic recording disks 8. By holding (sandwiching) the magnetic recording disks 8 between the clampers 154 and the placement parts 28c, the magnetic recording disks 8 and the spacers 152 are fixed to the cylindrical part 28b of the hub 28. Thereby, the magnetic recording disks 8 can rotate together with the hub 28.

The sleeve hole 28f is formed at the center of the hub 28 for allowing the sleeve 106 to be inserted therein. The sleeve hole 28f retains the sleeve 106 by having an upper end side of the sleeve 106 fixed thereto. The sleeve 106 may be fixed to the hub 28 by way of press-fitting, adhesive attachment, or both relative to the sleeve hole 28f.

### (Housing)

The housing 102 includes the circular ring-shaped support part 102a that supports the shaft 26, the cylindrical part 102b that projects upward from the outer peripheral edge of the support part 102a, and the thrust member 27. The cylindrical part 102b surrounds the lower end part of the sleeve 106. The lower end part of the shaft 26 is attached to the support part 102a of the housing 102 by way of press-fitting, adhesive attachment, or both. Further, the cylindrical part 102b is fixed to the base 4 by way of press-fitting, adhesive attachment, or both relative to the center hole 4e of the base 4.

The thrust member 27 is a circular ring-shaped member that is fixed to the inner peripheral surface of the cylindrical part 102b. The thrust member 27 is provided to sandwich the circular ring part 106b of the sleeve 106 between the support part 102a of the housing 102 in the axial direction. Thereby, the hub 28 and the sleeve 106 are prevented from detaching from the shaft 26.

### (Dynamic Pressure Generation Part)

The first thrust dynamic pressure generation part 164 is formed between the lower surface of the thrust member 27 and the upper surface of the circular ring part 106b of the sleeve 106. The first thrust dynamic pressure generation groove 54 is formed in the upper surface of the circular ring part 106b of the sleeve 106. The first thrust dynamic pressure generation groove 54 may have, for example, a herring bone shape or a spiral shape. It is to be noted that the first thrust dynamic pressure generation groove 54 may be formed in a part of the lower surface of the thrust member 27.

Further, the second thrust dynamic pressure generation part 166 is formed between the lower surface of the circular ring part 106b of the sleeve 106 and the upper surface of the support part 102a of the housing 102. The second thrust dynamic pressure generation groove 56 is formed in the lower surface of the circular ring part 106b of the sleeve 106. The second thrust dynamic pressure generation groove 56 may have, for example, a herring bone shape or a spiral shape. The second thrust dynamic pressure generation groove 56 may be formed in the upper surface of the support part 102a of the housing 102.

When the hub 28 and the sleeve 106 are rotated with respect to the shaft 26 and the base 4, dynamic pressure is exerted on the lubricant 92 in each of the first thrust dynamic pressure generation part 164 and the second thrust dynamic pressure generation part 166. Accordingly, the hub 28 can be supported in the axial direction by the dynamic pressure generated in the first and second thrust dynamic pressure generation parts 164, 166 in a non-contacting state with respect to the housing 102.

It is to be noted that the sleeve 106 may include a communication hole(s) that bypass the predetermined areas provided with the lubricant 96, so that the difference of pressure exerted on the lubricant 92 can be reduced. As examples of the communication hole, the sleeve 106 of this embodiment may include bypass communication holes 71, 72 that bypass the upper surface side of the sleeve 106 and the lower surface side of the sleeve 106. The bypass communication holes 71, 72 can reduce the difference of pressure exerted on the lubricant 92 provided in the predetermined areas of the disk drive device 300. Accordingly, the behavior of the lubricant 92 can be maintained to be steady.

### (Seal Part)

The gas-liquid interface 116 of the lubricant 92 is formed between the inner peripheral surface of the thrust member 27 and the outer peripheral surface of the sleeve 106. The seal part 120 is provided to retain the gas-liquid interface 116 of the lubricant 92.

In the seal part 120, each the inner peripheral surface of the thrust member 27 and the outer peripheral surface of the sleeve 106 is inclined to form a tapered shape that gradually becomes narrower toward the lower side of the seal part 120. Owing to the shape of the seal part 120, more force is exerted onto the lubricant 92 as the space between the inner peripheral surface of the thrust member 27 and the outer peripheral surface of the sleeve 106 becomes narrower toward the upper side of the seal part 120. Accordingly, the lubricant 92 can be sealed in-between the thrust member 27 and the sleeve 106.

### (Disk Fitting Section and Radial Gap)

The disk fitting section Da is a section of the disk drive device 300 extending from the upper surface of the placement part 28c of the hub 28 to the lower surface of the clamper 154 in the axial direction. That is, the disk fitting section Da is a section that extends from a lowermost surface to an uppermost surface of one or more magnetic recording disks 8 placed in a superposed manner on the placement part 28c in the axial direction.

The radial gap Rg is a section that extends from the upper end of the first radial dynamic pressure generation part 160 to the lower end of the second radial dynamic pressure generation part 162 in the axial direction. That is, the radial gap Rg is a section at which the sleeve 106 is supported by the shaft 26 via the installing hole 106a.

Similar to the disk drive device 100 of the first embodiment, the disk fitting section Da of the disk drive device 300 according to the third embodiment of the present invention is provided in the radial gap Rg in the axial direction. That is, the upper end of the disk fitting section Da is positioned lower than the upper end of the radial gap Rg in the axial direction (i.e. lower than the upper end of the first radial dynamic pressure generation part 160). Further, the lower end of the disk fitting section Da is positioned higher than the lower end of the radial gap Rg in the axial direction (i.e. higher than the lower end of the second radial dynamic pressure generation part 162).

Owing to this configuration, the rotation of the hub 28 is stabilized. Thereby, the driving load of the motor of the disk drive device 300 can be reduced. Thus, the life-span of the disk drive device 300 can be increased.

It is to be noted that, even in a case where the lower end of the disk fitting section Da is lower than the lower end of the radial gap Rg (i.e. lower than the lower end of the second radial dynamic pressure generation part 162) in the axial direction, it is possible to attain the same effects as the case where the lower end of the disk fitting section Da is positioned higher than the lower end of the radial gap Rg in the axial direction (i.e. higher than the lower end of the second radial dynamic pressure generation part 162).

Hence, with the disk drive device 300 according to the third embodiment of the present invention, rotation of the hub 28 can be stabilized, and the driving load of the motor of the disk drive device 300 can be reduced. Accordingly, the disk drive device 300 can stably operate for a long period without encountering failure or the like.

### Fourth Embodiment

Next, a fourth embodiment of the present invention is described with reference to the accompanying drawings. It is to be noted that like components/parts are denoted with like reference numerals as those of the third embodiment and are not further explained.

### <Configuration of Bearing Mechanism>

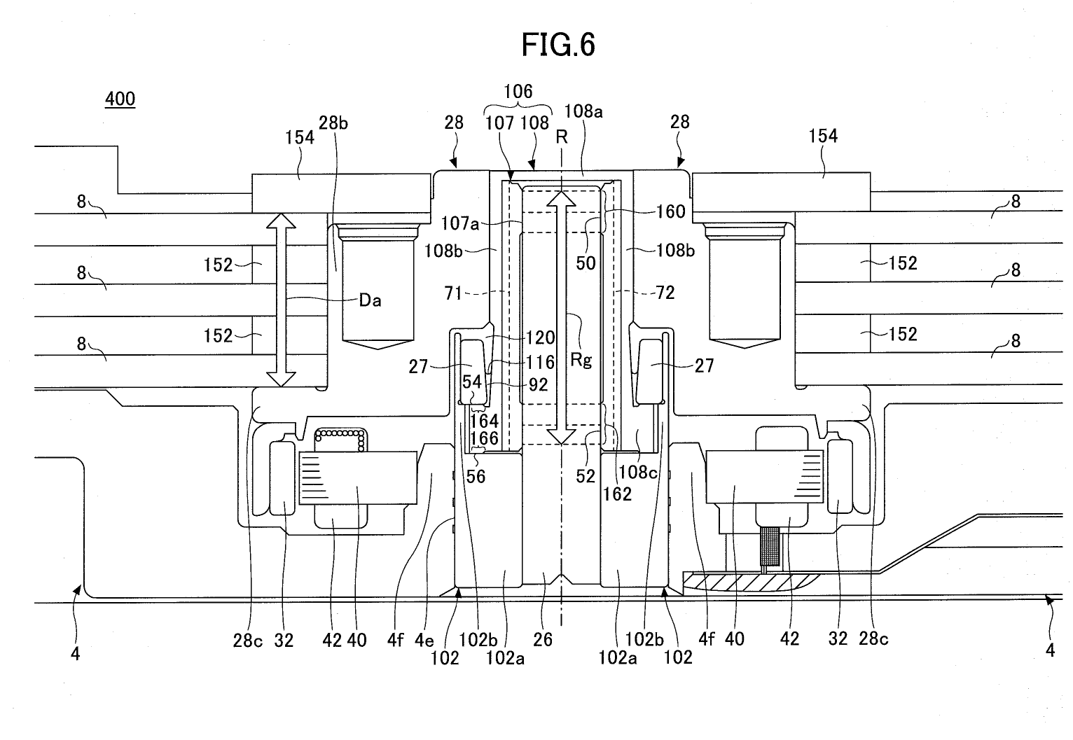

FIG. 6 is a cross-sectional view illustrating a configuration of a bearing mechanism of the disk drive device 400 according to a fourth embodiment of the present invention.

The disk drive device 400 includes a rotating member that rotates while having one or more magnetic recording disks 8 placed thereon and a fixed member that rotatably supports the rotating member.

The rotating member includes the hub 28, the cylindrical magnet 32, the sleeve 106 serving as a bearing part, and the clamper 154. The fixed member includes the base 4, the shaft 26, the stator core 40, the coil 42, and the housing 102. The hub 28 is rotatably supported by the shaft 26 and the housing 102, and the shaft 26 is surrounded by the sleeve 106. Accordingly, the hub 28 and the sleeve 106 are rotated together. The lubricant 92 fills in-between the shaft 26 and the sleeve 106.

### (Sleeve)

The sleeve 106 includes an inner sleeve 107 and an outer sleeve 108.

The inner sleeve 107 includes an installing hole 107a to which the shaft 26 is installed. The inner sleeve 107 is fixed to the outer sleeve 108 by way of pressing-fitting, adhesive attachment, or both. The inner sleeve 107 surrounds the upper end side of the shaft 26. A groove or a flat surface is provided at an outer periphery of the inner sleeve 106, so that the bypass communication holes 71, 72 can be formed between the outer peripheral surface of the inner sleeve 106 and the inner peripheral surface of the outer sleeve 108.

The outer sleeve 108 includes a cap part 108a, a cylindrical part 108b, and a circular ring part 108c. The cap part 108a covers the opening of the installing hole 107a of the inner sleeve 107 to prevent the lubricant 92 from scattering outside the sleeve 106. The cylindrical part 108b projects from the circumferential edge of the cap part 108a in the axial direction and surrounds at least a part of the inner sleeve 107. The circular ring part 108c projects from the lower end of the cylindrical part 108b toward the outer peripheral side in the radial direction.

The circular ring part 108c of the outer sleeve 108 is sandwiched between the support part 102a of the housing 102 and the thrust member 27 in the axial direction. Owing to this configuration, the hub 28 and the sleeve 106 can be prevented from detaching from the shaft 26 even in a case where the disk drive device 400 receives shock in the axial direction. This is because the circular ring part 108c is caught by the thrust member 27.

Alternatively, the cap part 108a, the cylindrical part 108b, and the circular ring part 108c may be separate components that constitute the outer sleeve 108. By constituting the outer sleeve 108 with the separate components, it becomes easy to process each of the separate components of the outer sleeve 108. In this embodiment, however, the cap part 108a, the cylindrical part 108b, and the circular ring part 108c are integrally formed. By integrally forming the outer sleeve 108, manufacturing error can be reduced and a bonding process can be simplified. Further, by integrally forming the cap part 108a and the cylindrical part 108b, the lubricant 92 can be positively prevented from scattering outside from the installing hole 107a.

### (Disk Fitting Section and Radial Gap)

The disk fitting section Da is a section of the disk drive device 400 extending from the upper surface of the placement part 28c of the hub 28 to the lower surface of the clamper 154 in the axial direction. That is, the disk fitting section Da is a section that extends from a lowermost surface to an uppermost surface of the one or more magnetic recording disks 8 placed in a superposed manner on the placement part 28c in the axial direction.

The radial gap Rg is a section that extends from the upper end of the first radial dynamic pressure generation part 160 to the lower end of the second radial dynamic pressure generation part 162 in the axial direction. That is, the radial gap Rg is a section at which the inner sleeve 107 is supported by the shaft 26 via the installing hole 107a.

Similar to the disk drive device 100 of the first embodiment, the disk fitting section Da of the disk drive device 400 according to the fourth embodiment of the present invention is provided in the radial gap Rg in the axial direction. That is, the upper end of the disk fitting section Da is positioned lower than the upper end of the radial gap Rg in the axial direction (i.e. lower than the upper end of the first radial dynamic pressure generation part 160). Further, the lower end of the disk fitting section Da is positioned higher than the lower end of the radial gap Rg in the axial direction (i.e. higher than the lower end of the second radial dynamic pressure generation part 162).

Owing to this configuration, the rotation of the hub 28 is stabilized. Thereby, the driving load of the motor of the disk drive device 400 can be reduced. Thus, the life-span of the disk drive device 400 can be increased.

It is to be noted that, even in a case where the lower end of the disk fitting section Da is lower than the lower end of the radial gap Rg (i.e. lower than the lower end of the second radial dynamic pressure generation part 162) in the axial direction, it is possible to attain the same effects as the case where the lower end of the disk fitting section Da is positioned higher than the lower end of the radial gap Rg in the axial direction (i.e. higher than the lower end of the second radial dynamic pressure generation part 162).

Hence, with the disk drive device 400 according to the fourth embodiment of the present invention, rotation of the hub 28 can be stabilized, and the driving load of the motor of the disk drive device 400 can be reduced. Accordingly, the disk drive device 400 can stably operate for a long period without encountering failure or the like.

The disk drive devices 100-400 according to the first-fourth embodiments of the present invention are described fixed shaft type disk drive devices in which the hub 28 and the sleeve 106 are rotated relative to a fixed shaft 26. However, the disk drive devices 100-400 may be rotating shaft type disk drive devices in which the shaft 26 rotates together with the hub 28.

Further, the present invention is not limited to these embodiments, but variations and modifications may be made without departing from the scope of the present invention.

For example, although the above-described embodiments are explained with the lower end of the shaft 26 being fixed to the fixed member, an upper end of the shaft 26 may also be fixed to and supported by the top cover 2. For example, the upper end of the shaft 26 may be fixed to the top cover 2 by fastening through-holes provided in the top cover 2 and screw holes provided in the shaft 26 with screws. Thus, owing to this configuration in which both ends of the shaft 26 are fixed to the fixed member, operation stability of the disk drive device 100-400 with respect to vibration, shock, or the like can be improved.

The present application is based on and claims the benefit of priority of Japanese Priority Application No. 2013-145414 filed on Jul. 11, 2013, with the Japanese Patent Office, the entire contents of which are hereby incorporated by reference.

What is claimed is:

1. A rotary device comprising:
a fixed member including a shaft body having a first shaft end and a second shaft end opposite to the first shaft end;
a rotating member that is rotatably supported by the fixed member, the rotating member including
a bearing body that accommodates the second shaft end, and
a fitting part to which a recording disk is to be fitted at a disk fitting section; and
first and second dynamic pressure generation parts provided in a space between the fixed member and the rotating member;
wherein the disk fitting section includes a first end provided toward the first shaft end and a second end provided toward the second shaft end,
wherein the bearing body is supported by the shaft body at a radial gap section extending between the first and second dynamic pressure generation parts in an axial direction of the shaft body,
wherein the second end of the disk fitting section is positioned within the radial gap section with respect to the axial direction.

2. The rotary device as claimed in claim 1, wherein the first end of the disk fitting section is positioned within the radial gap section with respect to the axial direction.

3. The rotary device as claimed in claim 1,
wherein the bearing body includes an installing hole into which the shaft body is inserted,
wherein the rotating member further includes a cap that covers the installing hole.

4. The rotary device as claimed in claim 1,
wherein the fixed member further includes a housing having a shaft support part that fixedly supports the first shaft end and a surrounding part that surrounds the bearing body,
wherein the rotating member includes a thrust member having a circular ring shape and surrounding at least a part of the housing.

5. The rotary device as claimed in claim 4,
wherein the housing includes a flange part extending outward in a radial direction from the surrounding part,
wherein the flange part includes a flange surface provided toward the first shaft end,
wherein the thrust member includes a surface that faces the flange surface with respect to the axial direction.

6. The rotary device as claimed in claim 5, further comprising:
a thrust dynamic pressure generation part provided between the flange part and the thrust member with respect to the axial direction.

7. The rotary device as claimed in claim 4, wherein a seal part is provided between the housing and the thrust member.

8. The rotary device as claimed in claim 3, wherein the rotating member includes a cylindrical part that projects from the a circumferential edge of the cap in the axial direction and surrounds at least a part of the bearing body.

9. The rotary device as claimed in claim 8, wherein the cap and the cylindrical part are integrally formed.

10. A rotary device comprising:
a fixed member including a shaft having a first, shaft end and a second shaft end opposite to the first shaft end;
a rotating member that is rotatably supported by the fixed member, the rotating member including
a bearing body that accommodates the second shaft end, and
a fitting part to which a recording disk is to be fitted at a disk fitting section; and
a radial dynamic pressure generation groove formed in at least one of the fixed member and the rotating member;
wherein the disk fitting section includes a first end provided toward the first shaft end and a second end provided toward the second shaft end,
wherein the radial dynamic pressure generation groove extends in an axial direction of the shaft body,
wherein the first and second ends of the disk fitting section are positioned within the radial dynamic pressure generation groove with respect to the axial direction.

11. The rotary device as claimed in claim 10,
wherein the bearing body includes an installing hole into which the shaft body is inserted,
wherein the rotating member further includes a cap that covers the installing hole.

12. The rotary device as claimed in claim 10,
wherein the fixed member further includes a housing having a shaft support part that fixedly supports the first shaft end and an surrounding part that surrounds the bearing body,
wherein the rotating member includes a thrust member having a circular ring shape and surrounding at least a part of the housing.

13. The rotary device as claimed in claim 12,
wherein the housing includes a flange part extending outward in a radial direction from the surrounding part,
wherein the flange part includes a flange surface provided toward the first shaft end,
wherein the thrust member includes a surface that faces the flange surface with respect to the axial direction.

14. The rotary device as claimed in claim 13, further comprising:
a thrust dynamic pressure generation part provided between the flange part and the thrust member with respect to the axial direction.

15. The rotary device as claimed in claim 12, wherein the rotating member includes a cylindrical part that projects from a circumferential edge of the cap in the axial direction and surrounds at least a part of the bearing body.

16. The rotary device as claimed in claim 15, wherein the cap and the cylindrical part are integrally formed.

17. A rotary device comprising:
a fixed member including a shaft body having a first shaft end and a second shaft end opposite to the first shaft end;
a rotating member that is rotatably supported by the fixed member, the rotating member including
a bearing body that accommodates the second shaft end, and
a fitting part to which a recording disk is to be fitted at a disk fitting section; and
first and second dynamic pressure generation parts provided in a space between the fixed member and the rotating member;
wherein the disk fitting section includes a first end provided toward the first shaft end and a second end provided toward the second shaft end,
wherein the bearing body is supported by the shaft body at a radial gap section extending between the first and second dynamic pressure generation parts in an axial direction of the shaft body,
wherein the second end of the disk fitting section is positioned within the radial gap section with respect to the axial direction,
wherein the bearing body includes an installing hole into which the shaft body is inserted,
wherein the rotating member further includes a cap that covers the installing hole.

18. The rotary device as claimed in claim 17, wherein the first end of the disk fitting section is positioned within the radial gap section with respect to the axial direction.

19. The rotary device as claimed in claim 17, wherein the rotating member includes a cylindrical part that projects from a circumferential edge of the cap in the axial direction and surrounds at least a part of the bearing body.

20. The rotary device as claimed in claim 19, wherein the cap and the cylindrical part are integrally formed.
